(19) United States
(12) Patent Application Publication
(10) Pub. No.: US 2020/0042965 A1
(43) Pub. Date: Feb. 6, 2020

(54) LINKING EVENTS WITH LINEAGE RULES

(71) Applicant: PeerNova, Inc., San Jose, CA (US)

(72) Inventors: Gangesh Kumar Ganesan, Mountain View, CA (US); Alexei Kozlenok, San Jose, CA (US)

(21) Appl. No.: 16/529,773

(22) Filed: Aug. 1, 2019

Related U.S. Application Data
(60) Provisional application No. 62/713,542, filed on Aug. 2, 2018.

(51) Int. Cl. G06Q 20/10; G06F 9/54

(52) U.S. Cl. CPC G06Q 20/10; G06F 9/542

(57) ABSTRACT

An event lineage system receives events related to processing a transaction. When event data is received, the event lineage system evaluates a set of lineage rules to generate one or more link signatures to link and associate the event with additional events. When another event related to the transaction occurs, a corresponding lineage rule is applied to that event which generates a link signature to match the prior link signature. To map between events with different schemas, the lineage rules define which event data to use for generating a signature and an ordering of that event data, such that the resulting link signatures are consistent across different schemas and events.

### CROSS REFERENCE TO RELATED APPLICATIONS

This disclosure claims the priority benefit of U.S. provisional application No. 62/713,542, the contents of which are incorporated by reference in its entirety.

### BACKGROUND

The present disclosure generally relates to identifying related event processing for a transaction, and in particular to identifying a transaction lineage from event processing.

Entitles like financial institutions process many transactions on a daily basis. Each transaction involves multiple steps and processes. For example, transferring funds from a first person to a second person may involve verifying the identity of the first person, checking whether the first person has enough funds in his account for the transfer, checking whether the transfer has the characteristics of an in appropriate or reportable type of transfer (e.g., money laundering), and other steps. Typically, when storing data on such a transaction, a storage system will store general information for the transaction, such as X amount of funds were transferred from account A to account B on a certain date. However, there is typically no way to verify that the correct steps were followed in processing the transaction based on the storage of such general information.

In addition, modern transaction processing may occur across many different processing systems, each of which may have a separate part of the processing to perform. Each of these systems may have several processing steps that modify the transaction within a system, and different systems may represent the data in different data storage schema. As a result, the same transaction may generate many types of events at these different systems and be associated with different types of events and related data during this processing. When systems report completion of events related to processing the transaction, determining the transaction lineage and correlating processing of a particular transaction across systems may be challenging due to the changing nature of the data within and across systems.

### SUMMARY

An event lineage system processes data received for events to determine link signatures to associate received events with other events. Each event may represent a state or portion of processing for completing one or more transactions. The event may be described by event data that may describe a state or condition of the data after a processing event. The event data may thus describe a category of the event, processing codes, data values, and other event data. When link signatures match across events, the event lineage system may determine that the events are a part of the same transaction and thereby generate a transaction lineage for the events.

To generate the link signatures, the event lineage system maintains a set of lineage rules. The lineage rules describe parameters for converting the data elements for an event to link signatures of the event. Each lineage rule may include conditions that may be used to identify what type of events the rule should be applied to. These conditions may describe an event type, field values, data scheme types, and other aspects of event data. When an event (or respective event data) is received (or identified) by the event lineage system, the event lineage system determines which lineage rules match the event data and meet the conditions for applying those lineage rules. For each matching lineage rule, the lineage system applies the lineage rule to determine one or more link signatures for the event. The link signatures may be categorized as a child link signature or a parent link signature, designating whether the link signature is expected to match a preceding or following event.

To determine the event signature, the lineage rule specifies data elements of the event data (e.g., data values for particular fields) and an order for the data elements. To obtain a signature, the ordered data elements are hashed to generate a signature, for example by calculating the root of a Merkle tree having the data elements. Though the data schemas may differ across systems and have varying data elements, because the same underlying values can be identified in the different data schemas and ordered by the rules (which may differ in varying schemas and correspond to different field names), the resulting signature may still match. Using the link signatures, the event lineage system can match a series of events and determine a transaction lineage that represents the time-ordered sequence of events, even as events may be split to several systems and under differing data schemas.

In addition, the event signatures may be used to audit or evaluate successful transaction processing. The link signatures in some examples may represent “expected” prior and subsequent processing for a transaction. For example, when a parent link signature is generated by a lineage rule, this may indicate that the subject event is expected to come after a prior event, and should not be the initial event in a process. Likewise, when a child link signature is generated, this may indicate that the subject event is expected to have a subsequent event that will match the child link signature. When these link signatures are unmatched (e.g., a child link signature has no matching parent link signature or a parent link signature has no matching child link signature), it may thus indicate an error with successfully completing processing of that transaction, and may be used to identify or diagnose errors within the systems.

In addition, the lineage rules allow events to be received and processed by the event lineage system in parallel and without requiring the event lineage system to receive events in a particular order. To generate the link signatures for an event, typically the lineage rules use the data of the event itself, rather than some known relationship between this particular event and another event. As a result, the events can be processed in parallel without maintaining a known list of pending transactions and attempting to link events to a pending transaction as events are received. This has the additional benefit that the transaction lineage may only be useful or required infrequently, such as demonstrating compliance for an audit or to identify the source of an error. Accordingly, storing the events and related link signatures may permit later determination of a transaction lineage when needed, rather doing so at the time events are received.

### BRIEF DESCRIPTION OF DRAWINGS

FIG. 1A illustrates an example set of events for completing a transaction.

FIG. 1B illustrates example event data according to one embodiment.

FIG. 2 is a detailed view of a data storage environment in accordance with one embodiment.

FIG. 3 is a block diagram of the event lineage system in accordance with one embodiment.

FIG. 4A illustrates an example data flow for an event to generate link signatures of the event, according to an embodiment.

FIG. 4B shows example lineage rule definitions according to one embodiment.

FIG. 5A illustrates an example set of event lineages generated for events related to a transaction, according to an embodiment.

FIG. 5B illustrates a transaction as represented by the event lineages of FIG. 5A after identifying matching link signatures, according to an embodiment.

FIG. 6 shows an example process for identifying transaction lineages, according to one embodiment.

FIG. 7 is a block diagram illustrating a functional view of a typical computer system for use as one of the systems illustrated in the environment of FIG. 2 in accordance with one embodiment

The figures depict, and the detail description describes, various non-limiting embodiments for purposes of illustration only. One skilled in the art will readily recognize from the following discussion that alternative embodiments of the structures and methods illustrated herein may be employed without departing from the principles described herein.

The figures use like reference numerals to identify like elements. A letter after a reference numeral, such as “102A,” indicates the text refers specifically to the element having that particular reference numeral. A reference numeral in the text without a following letter, such as “102,” refers to any or all of the elements in the figures bearing that reference numeral (e.g., “102” in the text refers to reference numerals “102A,” “102B,” “102C” and/or “102D” in the figures).

### DETAILED DESCRIPTION

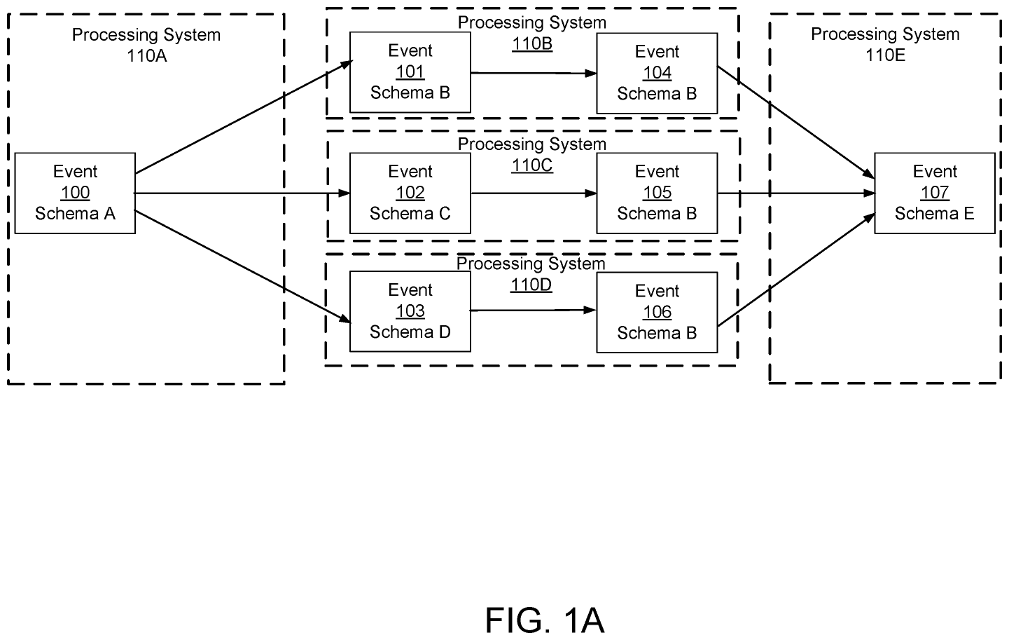

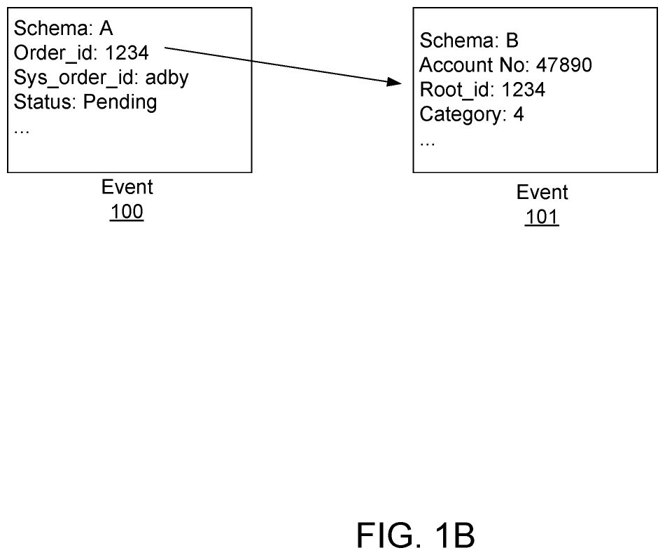

FIG. 1A illustrates an example set of events for completing a transaction. A transaction is one or more related events performed for the purpose of achieving a certain result. For example, a transaction may be transferring funds from a first account to a second account. The transfer of funds from the first account to the second account may involve events such as validating that the first and second accounts exist, verifying that the user that initiated the transfer is authorized to make the request, determining whether the first account has sufficient funds for the transfer, determining whether the amount of the transfer exceeds an established limit, determining whether the transfer has the characteristics of an improper or reportable (e.g., money laundering) type of transfer, among other steps. Each of these steps may be performed by various processing systems 110 which may pass information about the transaction to one another to complete the transaction. In the fund transfer example, one processing system may be the account holder's bank, while another processing system is a third party that evaluates fraud and money laundering characteristics. However, these systems may be controlled by the same entity and may also represent different systems, such as a back-end database, a legacy accounts management system, and so forth. Although a financial example is discussed here, the transaction may be any type of process with suitable events and data schemas as discussed herein.

As the transaction is processed, records of the processing may be generated, and represented here as events. These records may capture the state of the processing at a particular point, such as upon entry of a request to a processing system 110, and at intermediate processing steps at a processing system 110. For example, a processing system may generate each event related to the transaction and capture the state of the transaction when the event occurred. Continuing with the example of transferring funds from the first account to the second account, an event with related event data may be generated (e.g., as a record) for each of the events mentioned above that occurred for the transaction.

The event data for each particular event may be stored in varying schemas, according to the transaction, the particular event, configurations of the processing system 110 performing the event, and so forth. For example, event 100 at processing system 110A is stored as “Schema A” while other events 101-103 are associated with different schemas B, C, and D respectively. Each schema is a defined organization or structure of relevant event data. A schema may define a set of various data labels, associated data types, and permissible values of the data. For example, a schema may include a label “Transaction Id” of a data type “String” with permissible values of any string of characters up to a maximum length. As another example, a schema may define a data label of “processing code” as an integer with permissible values in the range of 1-8. These schemas may differ across different processing systems 110 and across different events. For example, within processing system 110B, event 101 has event data stored in Schema B. The same Schema B is used for event 104. However, at processing system 110C and 110D, the transactions between event 102 and 105, as well as between 103 and 106, change schemas within the respective processing systems 110. Typically, these changing schemas may or may not have equivalent or identical fields or data labels between different schemas.

The flow of a transaction may also split or combine across different processing systems 110. As shown in FIG. 1, event 100 is subsequently followed by events 101, 102, and 103, such that event 100 “fans out” to more than one event at different systems. Likewise, events 104, 105, and 106 “fan in” to event 107 at processing system 110E. Thus, when an event causes multiple subsequent events to begin, the processing flow fans out, while when multiple events complete before an event begins (e.g., event 107), these “fan in” to the reduced number of events.

Though shown here as relating to a single transaction, the schemas and processing systems 110 may not readily provide information or a unifying identifier to identify that the data relates to the same transaction. As discussed further below, “lineage rules” may be used to describe the relationships between the different events and event data. By applying the lineage rules to the event data, the event data itself may be used to describe “link signatures” from the event data to provide a means for identifying links between executed events when executing a specific transaction. This process is discussed in further detail below.

FIG. 1B illustrates example event data according to one embodiment. In this example, event 100 has schema A, and event 101 has schema B. As shown by FIG. 1B, these schemas may include different types of data having different possible values, and may otherwise represent data for the transaction differently according to the processing of each event. For example, schema A of event 100 includes fields for “Order_id” “Sys_order_id” and “Status” that are not in schema B of event 101. Schema B, however, does have some fields which may represent the same or similar information overlapping with schema A of event 100. The link signatures generated from this event data may use the data values and other information about these events to identify the links between them. In this example, event 100 may have a child link signature generated based on the “order_id” field, while a parent link signature may be generated for event 101 based on the “root_id” field. When these values are the same, the link signature generated for each will also be the same. Matching these link signatures permits an event lineage system to identify the lineage between these events.

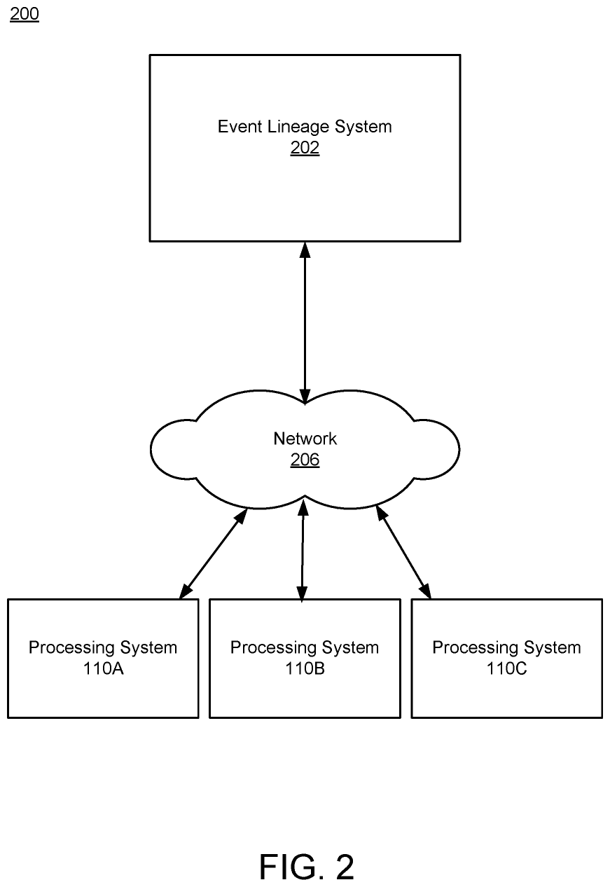

FIG. 2 is a detailed view of a data storage environment 200 in accordance with one embodiment. The data storage environment 200 includes an event lineage system 202 and one or more processing systems 110 connected via a network 206. Although the illustrated environment 200 includes only a select number of each entity, other embodiments can include more or less of each entity.

The processing systems 110A-C are computer systems that processes at least part of a transaction. As discussed with respect to FIG. 1, each processing system 110A, 110B, 100C may perform different portions of the transaction processing and generate relevant events. In one embodiment, the processing systems 110 are computer systems of a financial institution that processes financial transactions. For example, the financial transactions may be one or more of the followings: transfers between financial accounts, security trades, purchases of goods or services, payments, and loan underwriting. The processing systems may process transactions in collaboration with other systems, such as other processing systems 110 and the event lineage system 202.

Processing a transaction involves multiple steps and the execution of multiple processes. For example, transferring funds from a first account to a second account may involve, validating that the first and second accounts exist, verifying that the user that initiated the transfer is authorized to make the request, determining whether the first account has sufficient funds for the transfer, determining whether the amount of the transfer exceeds an established limit, determining whether the transfer has the characteristics of a money laundering type of transfer, etc. As the processing systems 110 complete events in the processing, the processing systems 110 report the related event data to the event lineage system 202.

In some embodiments, the processing systems 110 include a data storage system that stores data for each event of a transaction performed by that processing system. In addition, or as an alternative, the event data may be transmitted to and stored by the event lineage system 202. The storage of the event data may be performed by storing the events as one or more progressions related to each transaction. A progression is comprised of multiple records (e.g., the event data) that are chronologically and cryptographically linked. Each record of a progression represents an event related to the transaction of the progression. In the embodiment where multiple processing systems 110 collaborate to process transactions, each processing system 202 may store a subset of records of a progression or progressions that are linked to other progressions stored by another processing system 202.

The event lineage system 202 receives event data related to various events as transactions are processed. As discussed more fully below, the event lineage system 202 receives events and uses the event data and lineage rules to identify relationships between events and identify lineages between occurring events.

The network 206 represents the communication pathways between the processing system(s) 204, the event lineage system 202, and any other systems (not shown) communicating over the network 206. In one embodiment, the network 206 is the Internet and uses standard communications technologies and/or protocols. The network 206 can also utilize dedicated, custom, or private communications links that are not part of the public Internet. The network 206 may comprise any combination of local area and/or wide area networks, using both wired and wireless communication systems. In one embodiment, information exchanged via the network 206 is cryptographically encrypted and decrypted using cryptographic keys of the senders and the intended recipients.

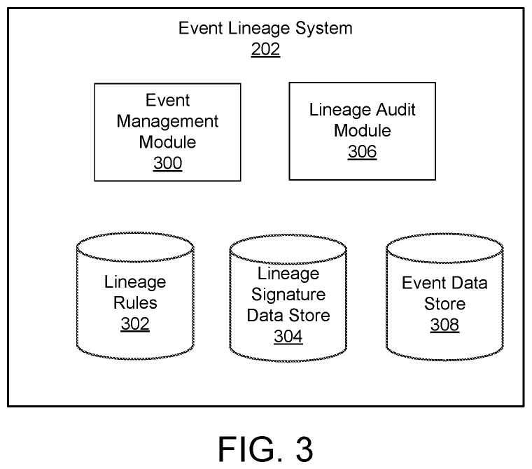

FIG. 3 is a block diagram of the event lineage system 202 in accordance with one embodiment. The event lineage system 202 includes an event management module 200, a lineage audit module 306, a set of lineage rules 302, a lineage signature data store 304, and an event data store 308. Those of skill in the art will recognize that other embodiments of the event lineage system 202 can have different and/or other components than the ones described here, and that the functionalities can be distributed among the components in a different manner.

The event management module 300 receives event data to evaluate event lineages and may store event data. When an event for a transaction occurs, the event management module 300 receives data from the processing system 110 for the event. An event may be, for example, a process executed as part of the transaction, a function applied to the transaction data or any other step of the transaction. The data identified by the event management module 300 may include the data processed, data input into a function, an identifier of the process/function applied, and the results of the process/function.

In some embodiments, the event management module 300 may store event data in an event data store 308. The event data may be stored by various means, and in one embodiment is stored as a set of progressions. These progressions may be cryptographically linked and immutable such that the event data may be subsequently verified after storage. In these circumstances, the event lineage system 202 may also operate to verify records and operate as a trusted record or ledger for the events.

The event management module 300 uses the lineage rules 304 to generate one or more link signatures reflecting expected prior and future events associated with the received event data. The lineage rules 302 define how to generate one or more link signatures from the event data. The lineage rules may be stored as a structured mark-up language, script or language or other form. For example, in various embodiments the lineage rules may be stored as YAMML or JSON.

The lineage rules 302 may define a set of conditions for defining which event data the lineage rules apply to. When a received event matches these conditions, the lineage rule is applied to generate the link signatures designated by the lineage rule. The conditions for applying a lineage rule may identify a data schema or processing system from which the event data was received. The conditions may also include an event type, or a data field value for a particular data item in the event data. These conditions may be particular to the schema designated by the lineage rule. For example, the lineage rule may specify that it relates to SchemaA when the value for field “ActivityName” in SchemaA has a value of “BOOK.”

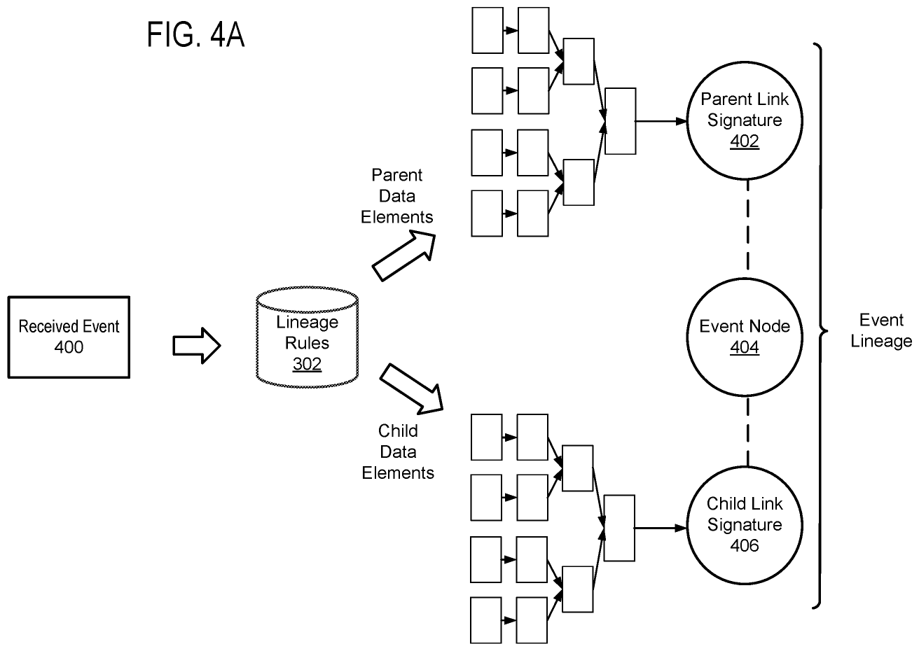

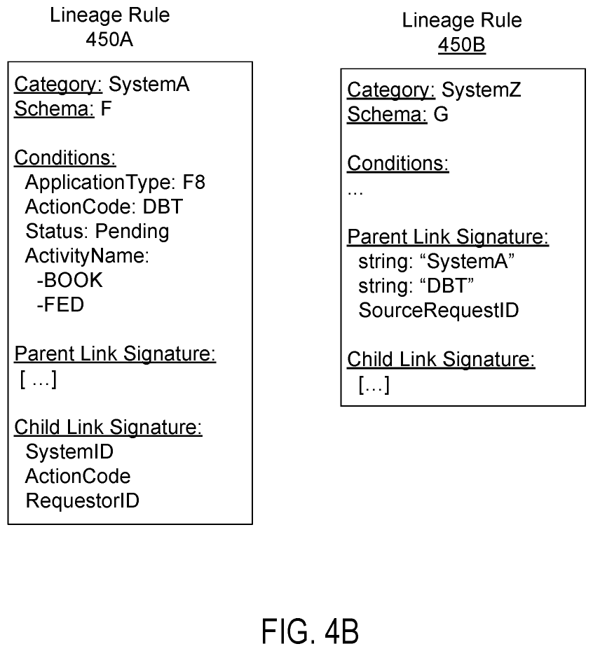

FIG. 4A illustrates an example data flow for an event to generate link signatures of the event. This process may be performed by event management module 300 as one example. A received event 400 is evaluated against the set of lineage rules 302. The lineage rules having conditions met by the received event are identified. Initially, the lineage rules may be filtered to identify rules which the received event may meet, for example by identifying rules that apply to the schema of the received event, or rules that apply to the system that processed the event and generated the event data. These may then be evaluated for any remaining conditions. More than one lineage rule may match the event. For each matching lineage rule, link signatures are generated as defined by the lineage rule. Each lineage rule may define one or more link signatures to generate for the event. The lineage rule identifies data elements of the event data (e.g., by specifying fields of the schema) to use in generating the link signature, and may also identify additional strings or data to be included in generating the signature. In addition, the lineage rule specifies an ordering of the data elements, such that the same data from different schemas may be consistently ordered when generating the link signature. Example lineage rules are shown in FIG. 4B.

To generate the link signature, the data identified by the lineage rule is hashed by a hashing function to determine a unique signature for the information to be linked. In one example, a hash function is applied to each data element to create hash values for each data element. In one embodiment, the hash function applied is an SHA-256 (Secure Hash Algorithm-256) function. These hash values may be organized as a tree in which hash values for data elements are combined. The order of data elements defined by the lineage rule is used to determine the order of data items being hashed and combined. In this example, the hashes may be combined to generate a root of a Merkle tree. This Merkle tree root may be used as the link signature for the event. In another example, the link signature may be generated by other hashing means, for example by concatenating data values in the defined order and determining a hash value of the concatenated data values.

As shown in FIG. 4A, the designated data elements may be organized as a Merkle tree to generate the link signatures. In FIG. 4A, a parent link signature 402 is determined by the parent data elements specified by the lineage rules, and a child link signature 406 is identified by child data elements specified by the lineage rules. Although one parent link and one child link are shown here, any number of link signatures may be generated as specified by the lineage rules. A designation of a link signature as a “parent” or a “child” may reflect the expected chronology and reliance of events upon one another. A “parent” event occurs before a “child” event, and the child is expected to use the event data of the parent in some way or may otherwise occur after a parent event. By designating link signatures as parent or child, when the link signatures are matched to one another, a directionality among the events can automatically be identified from the event associated with the parent link signature to the event associated with the corresponding child link signature.

The link signatures may be associated with an event node 404 for the event. An event node may represent the event when stored in association with the link signature, for example in a graph or other structure or data storage scheme. Together, the generated link signatures and event are termed an event lineage, representing the characteristic signatures of the received event. After generating the link signatures and event lineage, the link signatures may be stored in a lineage signature data store 304 shown in FIG. 3. The link signatures may be stored in the lineage signature data store 304 in various ways. In one example, the link signatures may be stored as a graph, such as a named graph. The link signatures may thus be stored as nodes of the named graph, and a connection in the graph may be made to a node representing the associated event. The connection may be labeled to represent the relationship between the link signature and the event, for example designating the link signature a parent or child of the event.

FIG. 4B shows example lineage rule definitions according to one embodiment. For clarity, certain aspects of these lineage rules are omitted, and additional lineage rules may have more or fewer defined link signatures or conditions for applying the lineage rules. Lineage rule 450A shows a first lineage rule for a category “SystemA” and schema “F.” The category and schema may be used to filter for relevant lineage rules, and indicate that lineage rule 450A should be considered to evaluate for this lineage rule when an event has a category SystemA and schema F. Lineage rule 450A further specifies various conditions for applying it to generate link signatures. In this case, the values of fields in the data schema (here, schema F) are evaluated: that an ApplicationType field has the value F8 an ActionCode field has the value DBT, a Status field has the value Pending, and an ActivityName field has values BOOK or FED. The conditions are shown here as static values, but in other circumstances may be more complex evaluations, for example accumulating values or comparing event data field values to a threshold.

In this example, the Parent Link Signature for lineage rule 450A is not shown for convenience. The child link signature for lineage rule 450A designates the values and ordering to be used in generating the link signature for a child link. In this example, the order specifies the SystemID, ActionCode, and RequestorID fields are used, in that order, for generating the link signature. These values may be selected from the data values of the Schema. In this example, the SystemID is “SystemA” and the “ActionCode” is DBT (which is known because the condition required the ActionCode field to equal DBT).

Lineage Rule 450B shows a corresponding lineage rule for an event expected to be a child of lineage rule 450A. Here, the parent link signature describes the data values for generating a corresponding link signature to the link signature generated by lineage rule 450A. However, since the lineage rule 450B relates to a different event and different Schema (Schema G), different data fields and values may be available. For example, Schema G may have no data fields corresponding to fields of Schema F, such as the “SystemID” or “ActionCode” values. Although that data thus may not be in the Schema of the matching data event for lineage rule 450B, these values may be designated in the lineage rule itself. In this case, the first two data values for the parent link signature are defined as strings, having values “SystemA” and “DBT.” These correspond to the expected values that would be used when lineage rule 450A uses its SystemID and ActionCode values from Schema F. By including these values in lineage rule 450B, this rule may be used to connect related events, even when the related schema does not directly have that data in its data fields. In addition, the parent link of lineage rule 450B includes the value of field SourceRequestID, which in Schema F corresponds to the RequstorID field. As a result, the child link signature of lineage rule 450A that uses values of [SystemID, Action Code, Requestor ID] (three values) may match the signature generated from lineage rule 450B that values of [“SystemA”, “DBT”, SourceRequestID] (three values).

By appropriately designating fields of various granularity, the lineage rules can account for different types of processes and transactions. For example, a link to represent an aggregation of all “DBT” actions from a particular system may need to represent a large number of parent events for the event aggregating these actions. This may be considered a “fan-in” relationship between these events, where one later event relies on many prior events. To do so in a lineage rule, the lineage rule may specify the type of events being aggregated, rather than refer to specific transaction identifiers. For example, the link signature may be defined as using the only the System ID or “ActionCode” fields in the rule for the event being aggregated. Likewise, the lineage rule for the aggregating event may create a link signature for defined values (e.g., specified strings) for the relevant system and ActionCode. In this way, link signatures can be used to define such “fan-in” or “fan-out” relationships across events.

The lineage rules may also specify additional operations for generating link signatures. For example, the lineage rules may also specify an ordering of data field values within a data field type for the schema. For example, a schema may permit the listing of any number of data elements, such as transaction times, or a list of strings. To ensure that these values are consistent across links, the lineage rule may specify that these values are “ordered by” a data field value or parameter. For example, strings (whichever strings are present in the event data for that field) may be “ordered by” an alphabetical ordering, or transaction times may be ordered chronologically. In addition, the lineage rule may designate that for each separate value of a field present in the event data, a link signature is to be generated for each value. Thus, if the data specifies three strings, a link signature may be generated for each of the three strings, using each string respectively in the generation of the link signature.

In these examples, the generation of a link signature may represent that there is an “expected” subsequent event that, when the transaction is complete, should generate a matching link signature. Accordingly, the link signatures may also be conditionally generated based on whether a further event is expected. The conditional generation may be performed by designating that an event is terminal when a condition is evaluated. In that case, child link signatures (or another type) may not be generated, or, link signatures may be flagged to not expect or require a match for that link signature to consider the transaction as succeeding.

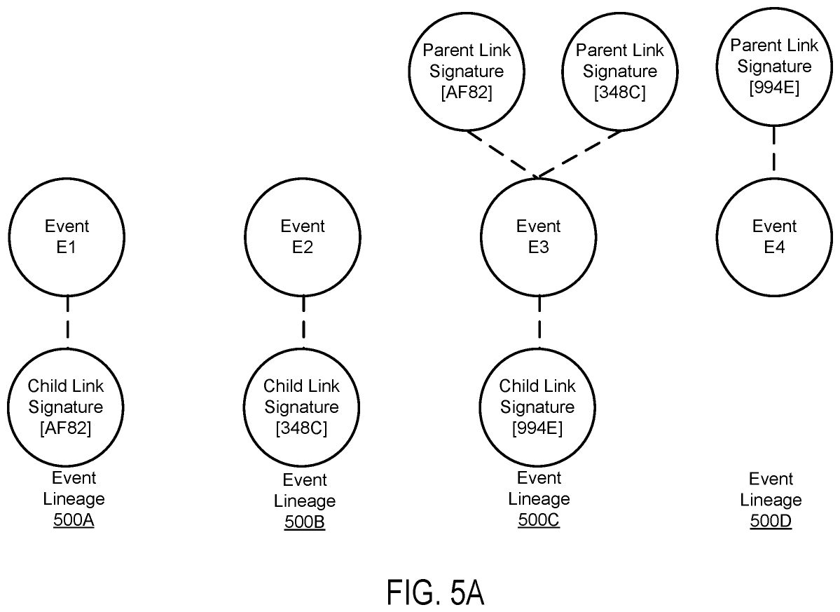

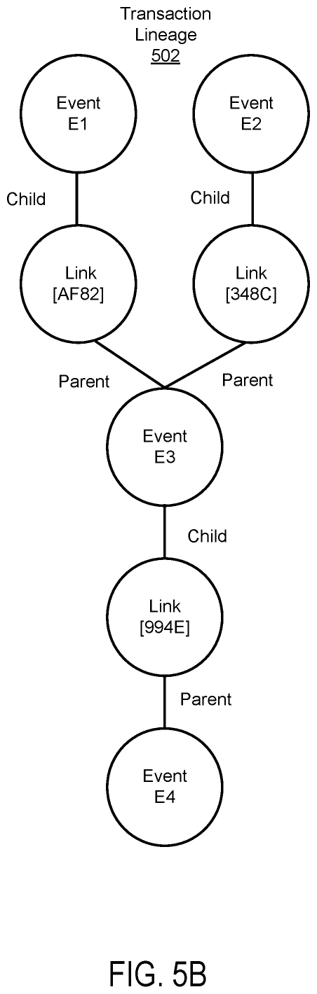

FIG. 5A illustrates an example set of event lineages 500A-D generated for events related to a transaction. In this example, four events E1-E4 were received, lineage rules identified, and link signatures were generated for these events. The event lineages shown in FIG. 5A represent these events after processing by lineage rules and as they may be stored in the event data store 308. Since each event may be processed by its own rule, the events may each be processed in parallel by the relevant rule and whenever they occur. As shown, event lineage 500A has a child link signature with value AF82; event lineage 500B has a child link signature with value 348C; event lineage 500C has two parent link signatures with values AF82 and 348C and a child link signature with value 994E; and event lineage 500D has a parent link signature with value 994E.

FIG. 5B illustrates a transaction as represented by the event lineages of FIG. 5A after identifying matching link signatures. As shown, by matching link signatures, the event lineage system 202 may determine that these events constitute transaction lineage 502 for a transaction. When event management module 300 adds nodes to the event data store 308, it may effectively generate a transaction lineage 502 by adding connections and nodes to the related graph that stores event and link information. When a match is identified between link signatures, the relationship between the events is automatically determined to identify events as related and thus generate the transaction lineage.

These transaction lineages may also be used to audit and verify that transactions correctly executed. Returning to FIG. 3, the lineage audit module 306 may evaluate events and links in the event data store to verify a transaction. The lineage audit module 306 may receive a request to verify a transaction successfully completed, or may periodically review events to generate transaction lineages or to determine if there were errors or missing events in a transaction lineage. To do so, the lineage audit module 306 identifies an event and determines the event lineage by identifying matching link signatures related to the event. Those matching link signatures indicate additional related events which themselves may have further link signatures. By traversing these event and link signatures, the lineage audit module 306 can determine whether a transaction has completed. In embodiments in which link signatures represent “expected” events, link signatures which are not matched by link signatures generated by another event may represent an error in executing the transaction, suggesting that the required or expected event failed to occur as expected. The lineage audit module 306 may also have an expected time for such events to occur, such that when no matching event is identified within a threshold time, the lineage audit module 306 can identify an error for that transaction.

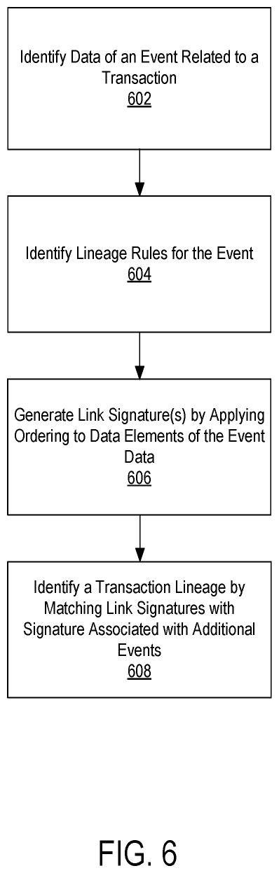

FIG. 6 shows an example process for identifying transaction lineages, according to one embodiment. This process is performed in one embodiment by the event lineage system 202. When events related to a transaction occur at processing systems, data related to the event is send or otherwise provided to the event lineages system, which identifies 602 the data for evaluation. Next, one or more relevant lineage rules are identified 604 for that event. These relevant lineage rules may be identified by evaluating conditions related to the events and identifying lineage rules which have conditions satisfied by the data. The relevant lineage rules define link signatures and an ordering of data for generating these link signatures. The link signature(s) defined by the relevant lineage rules are then generated 606 by applying a hash function to the event data elements in an ordering as defined the lineage rule. After generating link signatures for the event, a transaction lineage is identified 608 by matching the link signature to link signatures associated with (and generated by) additional other events. Using the lineage rules and link signatures, these events for a transaction can be identified across systems and varying schemas, even when the event data does not indicate any particular relationship between events or expressly indicate that the events relate to the same transaction.

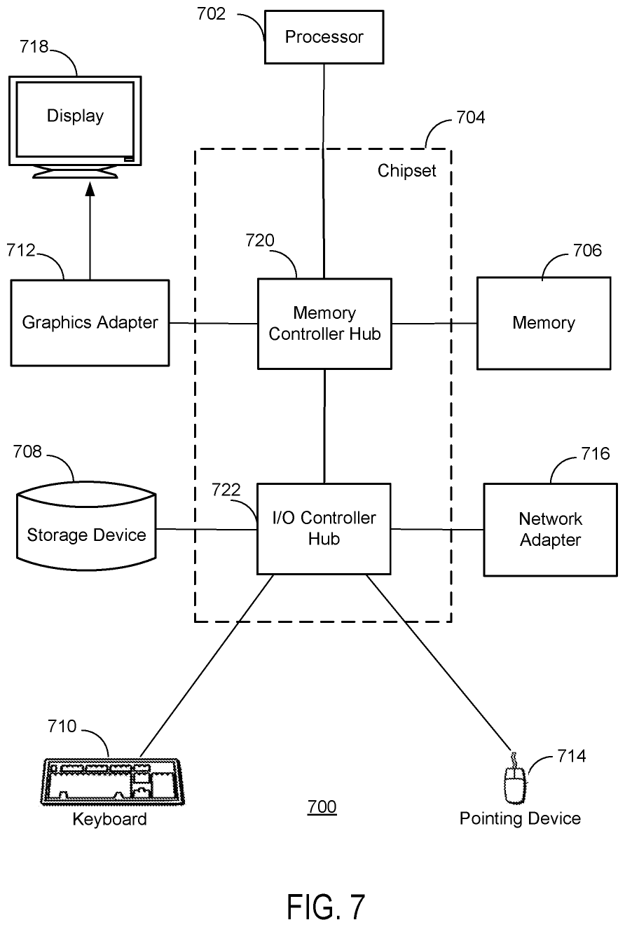

FIG. 7 is a block diagram illustrating a functional view of a typical computer system 700 for use as one of the systems illustrated in the environment 200 of FIG. 2 in accordance with one embodiment. Illustrated are at least one processor 702 coupled to a chipset 704. Also coupled to the chipset 704 are a memory 706, a storage device 708, a keyboard 710, a graphics adapter 712, a pointing device 714, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is a non-transitory computer-readable storage medium, such as a hard drive, compact disk read-only memory (CD-ROM), DVD, or a solid-state memory device. The memory 706 holds instructions and data used by the processor 702. The pointing device 714 may be a mouse, track ball, or other type of pointing device, and is used in combination with the keyboard 710 to input data into the computer system 700. The graphics adapter 712 displays images and other information on the display 718. The network adapter 716 couples the computer system 700 to the network 206. Some embodiments of the computer system 700 have different and/or other components than those shown in FIG. 5.

The computer 700 is adapted to execute computer program modules for providing the functionality described herein. As used herein, the term “module” to refers to computer program instruction and other logic for providing a specified functionality. A module can be implemented in hardware, firmware, and/or software. A module is typically stored on the storage device 708, loaded into the memory 706, and executed by the processor 702.

A module can include one or more processes, and/or be provided by only part of a process. Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

The types of computer systems 700 used by the systems of FIG. 2 can vary depending upon the embodiment and the processing power used by the entity. Further, the foregoing described embodiments have been presented for the purpose of illustration; they are not intended to be exhaustive or to limiting to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, described modules may be embodied in software, firmware, hardware, or any combinations thereof.

Reference in the specification to “one embodiment” or to “an embodiment” means that a particular feature, structure, or characteristic is included in at least one embodiment of the disclosure. The appearances of the phrase “in one embodiment” or “a preferred embodiment” in various places in the specification are not necessarily referring to the same embodiment.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects disclosed herein include process steps and instructions described herein in the form of a method. It should be noted that the process steps and instructions described herein can be embodied in software, firmware or hardware, and when embodied in software, can be downloaded to reside on and be operated from different platforms used by a variety of operating systems.

The embodiments discussed above also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the embodiments are not described with reference to any particular programming language. It will be appreciated that a variety of programming languages may be used to implement the teachings described herein, and any references below to specific languages are provided for disclosure of enablement and best mode.

While the disclosure has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the invention.

What is claimed is:

1. A method for determining a transaction lineage across transaction events, comprising:
identifying event data indicative of an event representing a portion of processing a transaction;
identifying one or more lineage rules for characterizing the event from a set of lineage rules;
for each identified lineage rule, generating one or more link signatures by applying an ordering specified by the lineage rule to a set of data elements in the event data and applying a hash function to the ordered set of data elements; and
identifying a transaction lineage describing a directed graph of events for the transaction by matching the one or more link signatures with link signatures associated with additional events.

2. The method of claim 1, wherein each lineage rule in the set of lineage rules specifies a set of conditions for the lineage rule; and
wherein identifying the one or more lineage rules from the set of lineage rules comprises identifying lineage rules having conditions matching the event data.

3. The method of claim 2, wherein the conditions include at least one of an event type, field value, and data schema type.

4. The method of claim 1, wherein the event data associated with the event is structured according to a first schema, and event data associated with at least one additional event is structured according to a second schema that differs from the first schema.

5. The method of claim 1, wherein the event is associated with a first processing system and the transaction lineage matches the event with additional events associated with a second processing system.

6. The method of claim 1, wherein the link signature is generated based on a merkle tree of the ordered set of data elements.

7. The method of claim 1, wherein the one or more link signatures includes a parent link signature and a child link signature and wherein matching a parent link signature to a link signature for an additional event indicates a prior event in the transaction lineage and matching a child link signature to a link signature for an additional event indicates a subsequent event in the transaction lineage.

8. The method of claim 1, further comprising:
identifying an unmatched link signature for the event that was not matched with link signatures associated with additional events; and
in response to identifying the unmatched link signature, identifying an error in processing the transaction.

9. The method of claim 1, wherein ordering the data elements includes sorting data elements having the same data type according to a parameter.

10. The method of claim 1, further comprising receiving a request to audit the transaction; wherein the link signatures are matched to identify the transaction lineage responsive to receiving the request to audit the transaction.

11. A non-transitory computer-readable storage medium comprising computer-executable instructions that when executed by one or more processors cause the one or more processors to perform steps comprising:
identifying event data indicative of an event representing a portion of processing a transaction;
identifying one or more lineage rules for characterizing the event from a set of lineage rules;
for each identified lineage rule, generating one or more link signatures by applying an ordering specified by the lineage rule to a set of data elements in the event data and applying a hash function to the ordered set of data elements; and
identifying a transaction lineage describing a directed graph of events for the transaction by matching the one or more link signatures with link signatures associated with additional events.

12. The non-transitory computer-readable medium of claim 11, wherein each lineage rule in the set of lineage rules specifies a set of conditions; and
wherein identifying the one or more lineage rules from the set of lineage rules comprises identifying lineage rules having conditions matching the event data.

13. The non-transitory computer-readable medium of claim 12, wherein the prerequisite event characteristics include at least one of an event type, field value, and data schema type.

14. The non-transitory computer-readable medium of claim 11, wherein the event data associated with the event is structured according to a first schema, and event data associated with at least one additional event is structured according to a second schema that differs from the first schema.

15. The non-transitory computer-readable medium of claim 11, wherein the event is associated with a first processing system and the transaction lineage matches the event with additional events associated with a second processing system.

16. The non-transitory computer-readable medium of claim 11, wherein the link signature is generated based on a merkle tree of the ordered set of data elements.

17. The non-transitory computer-readable medium of claim 11, wherein the one or more link signatures includes a parent link signature and a child link signature and wherein matching a parent link signature to a link signature for an additional event indicates a prior event in the transaction lineage and matching a child link signature to a link signature for an additional event indicates a subsequent event in the transaction lineage.

18. The non-transitory computer-readable medium of claim 11, the steps caused by the computer-executable instructions further comprising:
identifying an unmatched link signature for the event that was not matched with link signatures associated with additional events; and
in response to identifying the unmatched link signature, identifying an error in processing the transaction.

19. The non-transitory computer-readable medium of claim 11, wherein ordering the data elements includes sorting data elements having the same data type according to a parameter.

20. The non-transitory computer-readable medium of claim 11, the steps caused by the computer-executable instructions further comprising receiving a request to audit the transaction; wherein the link signatures are matched to identify the transaction lineage responsive to receiving the request to audit the transaction.
